(19) United States
(12) Patent Application Publication
(10) Pub. No.: US 2025/0116504 A1
(43) Pub. Date: Apr. 10, 2025

(54) IMAGE MEASURING APPARATUS

(71) Applicant: MITUTOYO CORPORATION, Kawasaki (JP)

(72) Inventors: Hiroyuki Yoshida, Kanagawa (JP); Yuki Yamasaki, Kanagawa (JP); Yuji Sadahira, Kanagawa (JP); Makoto Kaieda, Miyazaki (JP)

(21) Appl. No.: 18/907,959

(22) Filed: Oct. 7, 2024

(30) Foreign Application Priority Data
Oct. 10, 2023 (JP) 2023-175465

(51) Int. Cl. G01B 11/00; G06T 7/00; G06T 7/73

(52) U.S. Cl. CPC G01B 11/005; G06T 7/0006; G06T 7/73; G06T 2207/30164

(57) ABSTRACT

An image measuring apparatus includes: a mounting table on which a measurement object is placed; an image capturing unit disposed opposite the mounting table and captures an image of the measurement object; a control unit that controls the image measuring apparatus; and a memory unit that stores at least the shape of the measurement object and the measurement method corresponding to the measurement object, associated to each other. The control unit includes: a placement judging unit that judges whether or not the measurement object is placed on the mounting table in a state ready for measurement based on the image captured by the image capturing unit; and a measurement performing unit that selects a measurement method based on the shape of the measurement object appearing in the image and performs the measurement, when the placement judging unit determines that the measurement object is ready for measurement.

### CROSS-REFERENCE TO RELATED APPLICATION

This non-provisional application claims priority under 35 U.S.C. § 119 (a) from Japanese Patent Application No. 2023-175465, filed on Oct. 10, 2023, the entire contents of which are incorporated herein by reference.

### BACKGROUND OF THE INVENTION

### Field of the Invention

The present invention relates to an image measuring apparatus.

### Description of the Related Art

Conventionally, image measuring apparatuses have been known as instruments for measuring the dimensions of measurement objects (see, for example, JP2010-169584A). The image measuring apparatus captures an image of the measurement object, which is placed on a mounting table and illuminated by an illumination device, with an image capturing device, and measures the dimensions of each part of the measurement object using the image of the measurement object obtained from the image capturing device.

### SUMMARY OF THE INVENTION

### Problems to be Solved by the Invention

However, with conventional image measuring apparatus, the user must manually operate the image measuring apparatus, for example, by pressing the measurement start button, in order to start measurement and perform image capture by the image capturing device. In addition, the user may need to adjust the placement of the measurement object to ensure that the measurement object is accurately measured before starting the measurement. Therefore, conventional image measuring apparatus sometimes requires a lot of time and effort to start the measurement.

An object of the present invention is to provide an image measuring apparatus that can improve the efficiency of work without requiring any operation to start the measurement.

### Means for Solving the Problems

The image measuring apparatus according to the present invention comprises: a mounting table on which a measurement object is placed; an image capturing unit disposed opposite the mounting table and captures an image of the measurement object; a memory unit that stores at least the shape of the measurement object and the measurement method corresponding to the measurement object, associated to each other; and a control unit that controls the image measuring apparatus. The control unit includes: a placement judging unit that judges whether or not the measurement object is placed on the mounting table in a state ready for measurement based on the image captured by the image capturing unit; and a measurement performing unit that selects a measurement method corresponding to the measurement object based on the shape of the measurement object appearing in the image and performs the measurement, when the placement judging unit judges that the measurement object is placed in a state ready for measurement.

According to the present invention, the measurement can be started merely by properly placing the measurement object on the mounting table. Therefore, the image measuring apparatus does not require a separate operation to start the measurement, thereby improving the efficiency of the work.

The placement judging unit may constantly monitor changes in the image acquired from the image capturing unit, detect whether the image has changed from a fluctuating state to a stationary state, and determine that the measurement object has been placed in a state ready for measurement if the measurement object appears in the image in the stationary state in a state ready for measurement. The measurement performing unit then divides the measurement into multiple measurement processes and executes them sequentially. Each time the measurement process is performed, the measurement performing unit may determine whether or not an interrupt termination event is received, and if an interrupt termination event is received, the measurement performing unit may terminate the measurement in progress.

According to such a configuration, the measurement can be quickly terminated when there is a change in the image acquired from the image capturing unit while the measurement is being performed. This allows the next measurement to begin immediately when a new image of the stationary state is obtained.

In the present invention, the measurement performing unit may perform measurement for each measurement object when multiple measurement objects appear in the image acquired from the image capturing unit. The memory unit may store the shape and measurement method for multiple types of measurement objects correspondingly. When several types of measurement objects are captured in the image acquired from the image capturing unit, the measurement performing unit may select the measurement methods corresponding to the respective measurement objects based on the shape of the respective measurement objects and performs the measurements. The measurement performing unit may process the detection of multiple types of measurement objects in the image in parallel with multiple cores or threads of the processor (arithmetic processing unit) that realizes the measurement performing unit, thereby further improving the responsiveness of simultaneous measurements.

According to such a configuration, multiple pieces or multiple types of measurement objects can be measured concurrently.

It is preferred that the placement judging unit continuously monitors changes in the image acquired from the image capturing unit and detects whether or not the image has changed from a fluctuating state to a stationary state, and determines that the measurement object has been placed in a state ready for measurement on the mounting table if the measurement object appears in the image in the stationary state ready for measurement.

According to such a configuration, the image measuring apparatus starts the measurement when the measurement object is placed stationary on the mounting table, thereby ensuring that the measurement can be started even without any operation by the user.

### BRIEF DESCRIPTION OF THE DRAWINGS

FIG. 1 shows the appearance of an image measuring apparatus.

FIG. 2 shows a schematic diagram of the internal structure of the image measuring apparatus.

FIG. 3 shows a functional block diagram of the image measuring apparatus.

FIG. 4 is a flowchart showing the processing steps of the placement judging thread.

FIG. 5 is a flowchart showing the processing steps of the measurement program thread.

FIG. 6 shows an initial screen displayed on the display unit of the image measuring apparatus.

FIG. 7 shows the state displayed on the display unit of the image measuring apparatus during the judgment by the placement judging unit.

FIG. 8 shows the measurement results of the measurement performed by the measurement performing unit displayed on the display unit of the image measuring apparatus.

FIG. 9 shows another example of the measurement results of the measurement performed by the measurement performing unit displayed on the display unit of the image measuring apparatus.

FIG. 10 shows the state when the operation to pause, resume, or cancel the measurement is done displayed on the display unit of the image measuring apparatus.

### DETAILED DESCRIPTION OF THE EMBODIMENTS

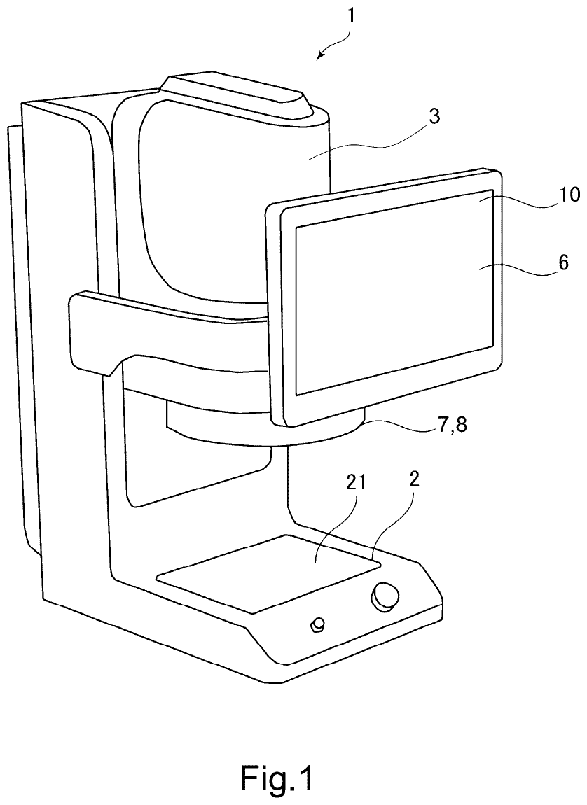

Hereinafter, an embodiment of the present invention will be described with reference to FIGS. 1 to 9.

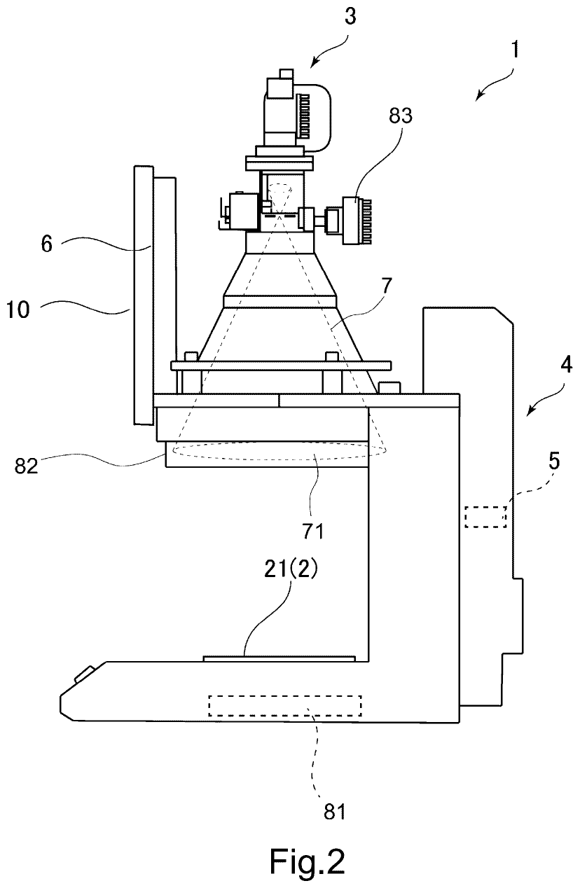

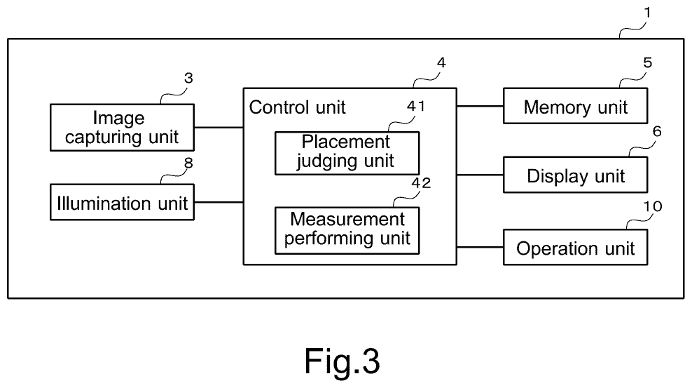

FIG. 1 is a schematic view illustrating the appearance of an image measuring apparatus according to the first embodiment. FIG. 2 shows a schematic diagram of the internal structure of the image measuring apparatus 1. FIG. 3 shows a functional block diagram of the image measuring apparatus 1. As shown in FIGS. 1 to 3, the image measuring apparatus 1 includes a mounting table 2, an image capturing unit 3, control unit 4, a memory unit 5, display unit 6, a telecentric optical system 7, an illumination unit 8, and an operation unit 10. The image measuring apparatus 1 captures the image of the measurement object (not shown) placed on the mounting table 2 using the image capturing unit 3, and the captured image is then computed by the control unit 4 to measure the dimensions of the measurement object or the like.

As shown in FIG. 1, the mounting table 2 is equipped with a top plate 21 transmitting light near the center thereof, and the measurement object is placed thereon. The image capturing unit 3 is disposed opposite the mounting table 2 and captures images of the measurement object. The image capturing unit includes an image sensor. The image sensor converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used. The telecentric optical system 7 forms an image of light from, for example, the direction of the mounting table 2 on the light-receiving surface. The telecentric optical system 7 may be provided with an objective lens 71 with a large aperture that can cover the entire area of the mounting table 2 in its field of view thereof.

The illumination unit 8 irradiates illumination light onto the measurement object. The illumination unit 8 may be provided with, for example, a transmitted illumination 81, a ring illumination 82, and a coaxial episcopic illumination 83.

As shown in FIG. 2, the transmitted illumination 81 irradiates light from below the top plate 21 toward the image capturing unit 3. The ring illumination 82 is provided at the periphery of the objective lens. The coaxial episcopic illumination 83 comes into the telecentric optical system via a beam splitter and illuminates the mounting table 2. When the image capturing unit 3 captures images, the illumination used and illuminance thereof are appropriately selected to obtain clear images without unwanted shadows of the measurement object.

The memory unit 5 is configured by, for example, a hard disk drive, a RAM, and the like. The memory unit 5 stores the program executed by the control unit 4 to control each part in the image measuring apparatus 1, various data necessary for measurement and the measurement results by the image measuring apparatus 1. The memory unit 5 stores at least the shape of the measurement object and the measurement method corresponding to the measurement object, associated with each other. The shape of the measurement object is, for example, CAD (Computer Aided Design) data of the measurement object or an image of the actual measurement object. The measurement method corresponding to the measurement object is, for example, a measurement program (part program) that specifies the points where dimensions are to be measured for the corresponding measurement object, the tolerances of the dimensions to be allowed, and so on. The memory unit 5 may store the shape and measurement method for multiple types of measurement objects correspondingly. When there are three types of parts A, B, and C, each of which has a different shape, it is recommended that memory unit 5 store CAD data, which is the data of the shape of each of parts A, B, and C, and a part program corresponding to each of parts A, B, and C.

The control unit 4 controls each part in the image measuring apparatus 1 to realize image capture and measurement by the image measuring apparatus 1. The control unit 4 may be realized by an arithmetic processing unit such as a CPU (Central Processing Unit), for example, executing a program stored in the memory unit 5. In the present embodiment, the control means 4 includes a placement judging unit 41 and a measurement performing unit 42.

The placement judging unit 41 acquires the image captured by the image capturing unit 3 and, based on the image, executes a placement judging thread that judges whether or not the measurement object is placed on the mounting table 2 in a state ready for measurement. Specifically, the placement judging unit 41 continuously monitors changes in the image acquired by the image capturing unit 3 and detects whether or not the image has changed from a fluctuating state to a stationary state. For example, the placement judging unit 41 may judge that if the image acquired from the image capturing means 3 has not changed for a predetermined period of time (e.g., 1 second), it has become a stationary state. If the measurement object appears in the image in the stationary state in a state ready for measurement, the placement judging unit 41 judges that the measurement object has been placed in a state ready for measurement on the mounting table 2. In the placement judging thread, the placement judging unit 41 issues a measurement start event that triggers the start of the measurement program thread by the measurement performing unit 42 and an interrupt termination event that interrupts the measurement program thread in progress. The detailed procedure of the placement judging thread is described later.

The term “the measurement object appears in the image in a state ready for measurement” means that the measurement object appears in the image in a state where measurement specified in the part program to be described later can be performed. For example, a state in which only a part of the measurement object appears in the image, or a state in which multiple measurement objects overlap, does not meet the definition of “appearing in a state ready for measurement”.

The measurement performing unit 42 executes the measurement program thread triggered by the issuance of a measurement start event in the placement judging thread. The detailed procedure of the measurement program thread is described later. The placement judging thread by the placement judging unit 41 and the measurement program thread by the measurement performing unit 42 are separate threads that can be executed in parallel or concurrently.

In the measurement program thread, the measurement method (part program) corresponding to the measurement object is selected based on the shape of the measurement object in the image captured by the image capturing unit 3, and the measurement is performed. When a part A is placed on the mounting table 2, for example, the measurement performing unit 42 selects and performs the measurement method corresponding to the part A based on the shape of the measurement object in the image captured by the image capturing unit 3. When several types of measurement objects are simultaneously placed on the mounting table 2 (i.e., when several types of measurement objects appear in the image acquired from the image capturing unit 3), the measurement performing unit 42 selects the measurement methods corresponding to the respective measurement objects based on the shape of the respective measurement objects and performs the measurements. For example, if part A and part B are simultaneously placed on the mounting table 2, the measurement performing unit 42 performs the measurement method corresponding to part A for part A in the image and performs the measurement method corresponding to part B for part B in the image. The measurement performing unit 42 may process the detection of multiple types of measurement objects in the image in parallel with multiple cores or threads of the processor (arithmetic processing unit) that realizes the measurement performing unit 42. This improves the responsiveness of simultaneous measurements. If an interrupt termination event is issued in the placement judging thread during the execution of the measurement program thread, the measurement performing unit 42 stops the measurement program thread being executed and terminates the process.

The measurement results measured by the measurement performing unit 42 are displayed on the display unit 6, which displays information about the image measuring apparatus 1. If a command to save the measurement results has been set in advance in the part program of the image measuring apparatus 1, the measurement results are automatically saved in the memory unit 5. In addition to the measurement results, the display unit 6 displays, for example, information on whether or not the image measuring apparatus 1 is ready for use, information on the measurement object stored in the memory unit 5, and information on the detailed settings of the image measuring apparatus 1. The display unit 6 is a liquid crystal panel with a touch sensor. The user can use the liquid crystal panel with a touch sensor as the operation unit 10 to make detailed settings of the image measuring apparatus 1 and to turn the power of the image measuring apparatus 1 on and off.

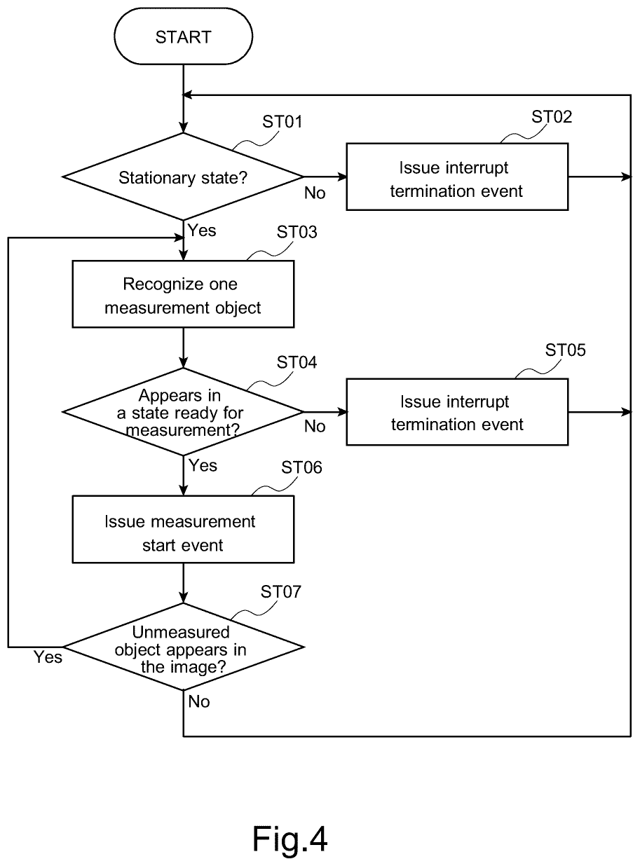

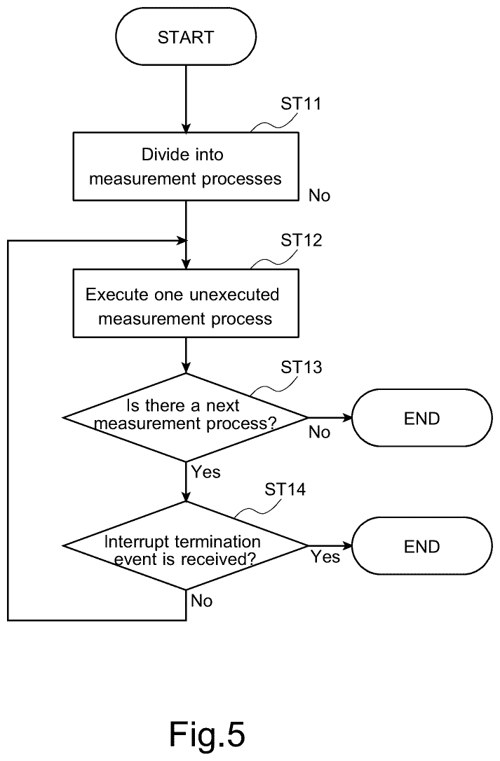

FIG. 4 is a flowchart showing the procedure of the placement judging thread executed by the placement judging unit 41. FIG. 5 is a flowchart showing the procedure of the measurement program thread executed by the measurement performing unit. The placement judging thread is the main thread in the measurement on the image measuring apparatus 1, and the measurement program thread is a sub-thread that is called from the placement judging thread as necessary.

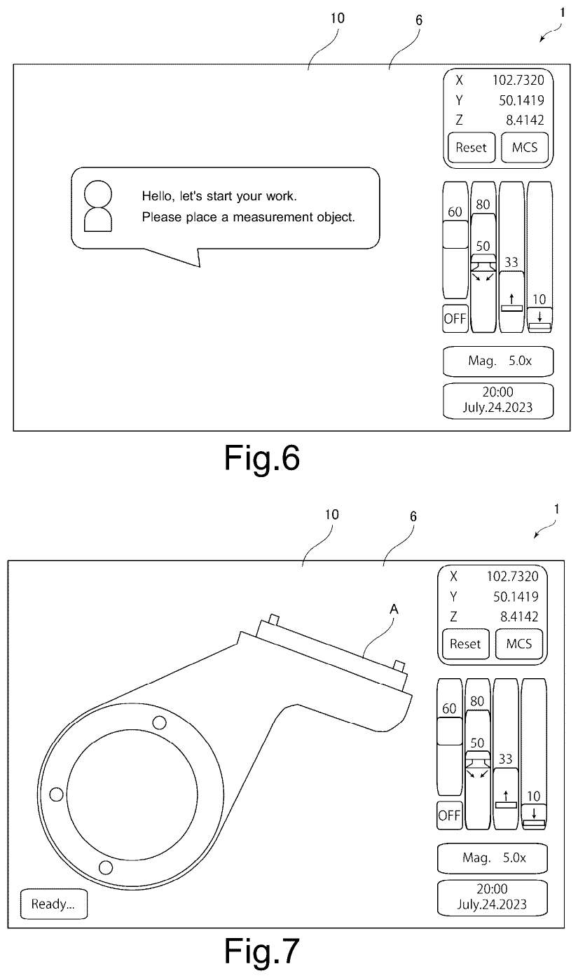

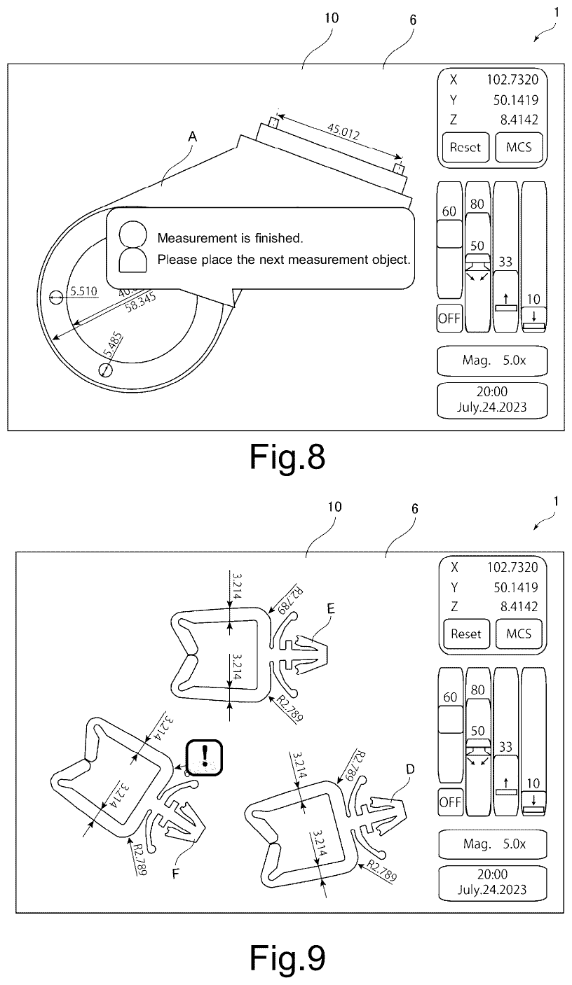

FIG. 6 shows an initial screen displayed on the display unit 6 of the image measuring apparatus 1. FIG. 7 shows the state displayed on the display unit 6 of the image measuring apparatus 1 during the judgment by the placement judging unit 41. FIGS. 8 and 9 show the measurement results of the measurement performed by the measurement performing unit 42 displayed on the display unit 6 of the image measuring apparatus 1. Hereafter, the measurement procedure using the image measuring apparatus 1 is explained with reference to FIGS. 4 and 5.

First, as shown in FIG. 4, when the image measuring apparatus 1 is activated and receives a predetermined operation to start measurement, the placement judging unit 41 starts the placement judging thread (START in FIG. 4). When the image measuring apparatus 1 starts the placement judging thread, the image measuring apparatus 1 constantly monitors changes in the image acquired by the image capturing unit 3 and judges whether the image captured by the image capturing unit 3 is in a stationary state or not (step ST01). If the image acquired from the image capturing unit 3 has not changed for a predetermined period of time (e.g., 1 second) since the last change, the placement judging unit 41 judges that the state has become stationary (“YES” in step ST01) and proceeds to step ST03. On the other hand, if the placement decision unit 41 judges that the state is not stationary (“NO” in step ST01), the placement judging unit issues an interrupt termination event (step ST02) and returns the process to step ST01. Upon issuance of the interrupt termination event in step ST02, the measurement program thread being executed is interrupted and terminated. Steps ST01 and ST02 will be repeated until the stationary state is reached. During the repetition, as shown in FIG. 7, the display unit 6 may indicate “Ready” or the like to inform the user that the device is waiting for the measurement object to be placed in a state ready for measurement.

If it is judged that the stationary state is reached in step ST01, the placement judging unit 41 recognizes one measurement object that has not yet been measured from the image in the stationary state (step ST03) and judges whether or not the measurement object is in the image in a state ready for measurement (step ST04). If a measurement object of the same shape as the measurement object stored in the memory unit 5 appears in the image captured by the image capturing unit 3 in a state ready for measurement (“Yes” in step ST04), the placement judging unit 41 moves the process to step ST06. On the other hand, if the measurement object does not appear in the image in the stationary state in a state ready for measurement (“No” in step ST04), the interrupt termination event is issued (step ST05), and the process returns to step ST01. Upon issuance of the interrupt termination event in step ST05, the measurement program thread being executed is interrupted and terminated.

If it is judged that the measurement object is captured in a state ready for measurement in step ST04, the placement judging unit 41 issues a measurement start event (step ST06). Upon issuance of the measurement start event, the measurement program thread is started in the measurement performing unit 42 for the measurement object recognized in step ST03. Then, it judges whether or not there is an unmeasured measurement object appearing in the image in the stationary state (step ST07). If there are no unmeasured measurement objects in the image in the stationary state (i.e., if measurement start events have been issued for all measurement objects) (“No” in step ST07), the placement judging unit 41 returns the process to step ST01 and continues monitoring changes in the image. On the other hand, if there is another measurement object in the image in the stationary state (“Yes” in step ST07), the placement judging unit 41 returns the process to step ST03, recognizes one new measurement object, and performs the same process described above for that measurement object.

In this manner, in the placement judging thread, if there is even one measurement object in the image in the stationary state that is not captured in a state ready for measurement, an interrupt termination event is issued and waits for a new image in the stationary state to be obtained. When an image is obtained in which all measurement objects are ready for measurement, the interrupt termination event is not issued, and the measurement start events are issued for all measurement objects. Then, unless an interrupt termination event is issued due to a change in the image or other circumstances, the measurement performing unit 42 will execute the measurement program thread.

The measurement performing unit 42 starts the measurement program thread in response to the issuance of the measurement start event. If several measurement objects appear in the image in a stationary state in a state ready for measurement, a measurement start event will be issued for each measurement object. When a plurality of measurement start events are issued in this manner, the measurement performing unit 42 may execute the measurement program threads one by one in the order in which the measurement start events are issued. Alternatively, the measurement performing unit 42 may execute a plurality of measurement program threads in parallel.

In the measurement program thread, the measurement performing unit 42 selects the part program corresponding to the recognized measurement object from the part programs stored in the memory unit 5 and performs the measurement using the selected part program. A measurement sequence that selects a part program and executes the selected program may take from a few seconds to several minutes to complete. The measurement execution section 42 divides the measurement sequence into short measurement processes, and each time one of the divided measurement processes is executed, judges the presence or absence of an interrupt termination event. The measurement program thread is then immediately interrupted and terminated when there is a change in the image or when the presence of even one measurement object that does not appear in the image in a state ready for measurement is found.

FIG. 5 is a flowchart showing the procedures of the measurement program thread. When the measurement start event is issued, the measurement performing unit 42 starts a measurement program thread (START in FIG. 5) for the measurement object recognized in step ST03 of the placement judging thread. At first, the measurement performing unit 42 divides a measurement sequence that selects and executes a part program into a plurality of short-time (e.g., 10 ms or less) measurement processes (step ST11). Then, the measurement performing unit 42 executes the measurement process with the earliest processing order among the unexecuted measurement processes (step ST12). The measurement performing unit 42 then determines whether there is a next measurement process (step ST13). If there is a next measurement process (“Yes” in step ST13), the measurement performing unit 42 determines whether or not an interrupt termination event is received (step ST14).

If the interrupt termination event is not received in step ST14 (“No” in step ST14), the measurement performing unit 42 returns the process to step ST12 and executes the next measurement process. In this manner, steps ST12-ST14 are repeated until it is determined that there is no next measurement process in step ST13. If it is determined that there is no next measurement process in step ST13 (“No” in step ST13; i.e., all measurement processes have been executed), the measurement performing unit 42 terminates the measurement program thread. At that time, a measurement termination event indicating that the measurement program thread has been terminated by executing the measurement to the end may be issued. Triggered by the issuance of the measurement termination event, the measurement performing unit 42 may start a measurement program thread corresponding to the next measurement start event.

When the measurement is performed to the end, and the measurement program thread terminates, the measurement results are stored in the memory unit 5. As shown in FIGS. 8 and 9, the measurement results are displayed in display unit 6. Then, as shown in FIG. 8, the user may be prompted to place the next measurement object by displaying “Measurement is finished. Please place the next measurement object.” or the like on the display unit 6.

The manner in which the measurement results are displayed on the display unit 6 is arbitrary. For example, dimensional lines and corresponding measured values at the points specified in the part program may be displayed on the measurement object in the image captured by the image capturing unit 3. If the dimensional tolerance of the measurement point is specified in the part program, a judgment may be made as to whether the measured value of the point is within the tolerance, and the result of the judgment may be overlaid on the measurement object in the image captured by the image capturing unit 3. For example, if the dimension of the measured part does not fall within the tolerance, a symbol such as “!” or the like on the image of the part displayed on the display unit 6 (see FIG. 9) to inform the user that there is a dimensional error.

On the other hand, if the interrupt termination event is received in step ST14 (“Yes” in step ST14), the measurement is interrupted, and the measurement program thread is terminated. With this configuration, the measurement performing unit 42 judges the presence or absence of an interrupt termination event each time it executes a single short measurement process that divides a measurement sequence during the execution of a measurement program thread. Therefore, if a change occurs in the image during the execution of the measurement program thread or if it is found that there is a measurement object in the image that is not captured in a state ready for measurement, the measurement can be promptly interrupted and the measurement program thread terminated without waiting for the measurement sequence to be executed to the end.

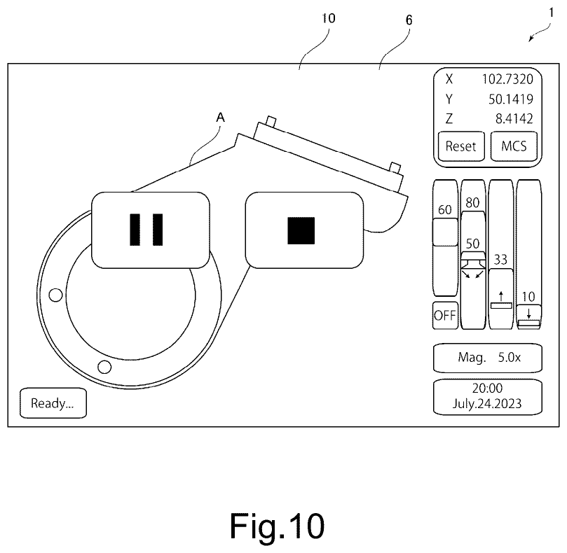

FIG. 10 shows the state when the operation to pause, resume, or terminate the measurement is done displayed on the display unit 6 of the image measuring apparatus 1. Although the image measuring apparatus 1 can basically perform measurement of the measurement object without requiring any operation by the user to start the measurement, as in the measurement process described above, the user can also operate the operation unit 10, such as a touch panel, to pause, resume, or stop the measurement, as shown in FIG. 10. By enabling such operations, the user can immediately deal with a situation such as having to interrupt the measurement in the middle of the measurement by operating the operation unit 10.

According to such an embodiment of the present invention, the following functions and effects can be achieved.

(1) The placement judging unit 41 of the image measuring apparatus 1 acquires an image of the mounting table 2 and judges whether or not the measurement object is placed in a state ready for measurement based on the image, and the measurement performing unit 42 selects a measurement method corresponding to the measurement object based on the shape of the measurement object in the image, and performs the selected measurement. This allows the measurement to be performed merely by placing the measurement object on the mounting table 2. Therefore, the image measuring apparatus does not require a separate operation to start the measurement, thereby improving the efficiency of the work.

### [Modification of Embodiment]

Note that the present invention is not limited to the above embodiments and modification, improvement, and the like within the spirit and the scope of the present invention are included.

For example, the image measuring apparatus is not limited to any particular detector type or detection method, as long as it is equipped with a mounting table on which the measurement object is placed and an image capturing unit provided opposite the mounting table to capture images of the measurement object.

In each of the above embodiments, the placement judging unit 41 judged that the object to be measured was “placed in a state ready for measurement” when the measurement object appeared in the image of a stationary state captured by the image capturing unit 3 in a state ready for measurement. However, the method for judging whether or not the object is “placed in a state ready for measurement” is not limited to this. For example, the placement judging unit 41 may judge that the measurement object is “placed in a state ready for measurement” if it appears in the image in a state ready for measurement, regardless of whether the image captured by the image capturing unit 3 is in a stationary state or not.

In each of the above embodiments, the image measurement apparatus may be provided with a warning unit that issues a warning to the user when the measurement object appears in the image captured by the image capturing unit in a state that is not ready for measurement. For example, the warning may be issued if only a portion of the measurement object appears in the image, if a plurality of measurement objects overlap, or if the measurement object is placed in an incorrect orientation, or the like. The warning unit may also issue the warning when the object in the image acquired from the image capturing unit does not match the shape of the measurement object (CAD data) stored in the memory unit 5. The method of issuing the warning is arbitrary. For example, the warning may be informed by indicating on the display unit that the measurement cannot be started, or by changing the color of the display screen of the display unit, the color of the text to be displayed, or the like. The warning may be issued by sounding a buzzer or other sound, by stimulating the human body in contact with the measuring apparatus, or by generating vibrations. In addition, warnings may be issued using light, for example, by illuminating or flickering a light-emitting component such as an LED, or by adjusting the light intensity of the backlight of the display screen.

### INDUSTRIAL APPLICABILITY

As described above, the present invention can be suitably applied to an image measuring apparatus.

What is claimed is:

1. An image measuring apparatus comprising:
a mounting table on which a measurement object is placed;
an image capturing unit disposed opposite the mounting table and captures an image of the measurement object;
a memory unit that stores at least the shape of the measurement object and the measurement method corresponding to the measurement object, associated with each other; and
a control unit that controls the image measuring apparatus,
wherein the control unit comprises:
a placement judging unit that judges whether or not the measurement object is placed on the mounting table in a state ready for measurement based on the image captured by the image capturing unit; and
a measurement performing unit that selects a measurement method corresponding to the measurement object based on the shape of the measurement object appearing in the image and performs the measurement, when the placement judging unit judges that the measurement object is placed in a state ready for measurement.

2. The image measuring apparatus according to claim 1, wherein the placement judging unit constantly monitors changes in the image acquired from the image capturing unit, detects whether the image has changed from a fluctuating state to a stationary state, and determines that the measurement object has been placed in a state ready for measurement if the measurement object appears in the image in the stationary state in a state ready for measurement, and
wherein the measurement performing unit divides the measurement into several measurement processes and performs the measurement processes sequentially, each time the measurement process is executed, the measurement performing unit determines whether or not an interrupt termination event is received, and if an interrupt termination event is received, terminates the measurement in progress.

3. The image measuring apparatus according to claim 1, wherein the measurement performing unit performs measurement for each measurement object when multiple measurement objects appear in the image acquired from the image capturing unit.

4. The image measuring apparatus according to claim 2, wherein the memory unit stores the shape and measurement method for multiple types of measurement objects correspondingly, and
when several types of measurement objects appear in the image acquired from the image capturing unit, the measurement performing unit selects the measurement methods corresponding to the respective measurement objects based on the shape of the respective measurement objects and performs the measurements.

5. The image measuring apparatus according to claim 1, wherein the placement judging unit continuously monitors changes in the image acquired from the image capturing unit and detects whether or not the image has changed from a fluctuating state to a stationary state, and determines that the measurement object has been placed in a state ready for measurement if the measurement object appears in the image in the stationary state ready for measurement.
